(19) United States
(12) Patent Application Publication
(10) Pub. No.: US 2020/0383349 A1
(43) Pub. Date: Dec. 10, 2020

(54) HIGHLY CAFFEINATED COCOA-BASED COMPOSITION AND METHODS OF MAKING AND USING THEREOF

(71) Applicant: Seattle Gummy Company, Seattle, WA (US)

(72) Inventors: Feng Wan, Sammamish, WA (US); William Brenden Carlson, Shoreline, WA (US)

(21) Appl. No.: 16/894,803

(22) Filed: Jun. 7, 2020

Related U.S. Application Data
(60) Provisional application No. 62/859,009, filed on Jun. 8, 2019.

(51) Int. Cl. A23G 1/50; A23L 29/00; A23L 33/105; A23L 29/25; A23L 29/212; A23L 33/135; A23L 33/155; A23L 33/175; A23L 29/262; A23L 2/39; A23L 2/56; A23L 33/24; A23L 29/30

(52) U.S. Cl. CPC A23G 1/50; A23L 29/035; A23L 33/105; A23L 29/25; A23L 29/212; A23L 33/135; A23L 29/37; A23L 33/175; A23L 29/262; A23L 2/39; A23L 2/56; A23L 33/24; A23L 33/155

(57) ABSTRACT

A highly caffeinated cocoa-based composition, comprising, a cocoa component comprising cocoa powder; a caffeinated component comprising caffeine, wherein the highly caffeinated cocoa-based composition comprises at least about 1% caffeine by weight; a fat component; a sweetening component, and a complexing component, wherein the complexing component is configured to reduce the bitterness of the caffeinated component, the cocoa component, or both.

### CROSS-REFERENCES TO RELATED APPLICATIONS

This application claims the benefit of priority from, and hereby incorporates by reference the entire disclosure, co-pending U.S. Provisional Application for Patent Ser. No. 62/859,009, filed Jun. 8, 2019.

### TECHNICAL FIELD

This application relates to generally to chocolate related compositions.

### BACKGROUND

Unless otherwise indicated herein, the materials described in this section are not prior art to the claims in this application and are not admitted being prior art by inclusion in this section.

Caffeine is a bitter-tasting compound. The xanthine core of caffeine contains two fused rings, a pyrimidinedione and imidazole. Pharmacologically, caffeine is a central nervous system stimulant. The compound is known to cross the blood brain barrier and reversibly blocks the action of adenosine on its receptor and consequently prevents the onset of drowsiness induced by adenosine. Caffeine also stimulates certain portion of the autonomic nervous system. The undesired effects from caffeine ingestion are common, including mild anxiety, jitteriness, hear palpitation, increased blood pressure, insomnia, increase sleep latency and reduced coordination. Researches have positively associated caffeine use with anxiety and panic disorders

Chocolate is a composite confectionery. The distinctive ingredients of chocolate are cacao butter and cocoa powder both of which are derived from the plant, Theobroma cacao, related species such as Theobroma cupuacu and other members of the Malvaceae family. The seeds are extracted from the pods. The fat, cacao butter, and the flesh of the seeds are separated. The flesh is processed by various methods to yield cocoa powder. Some types of processing lead to Natural, American, and Dutch type cocoa powder. The type of processing imparts distinctive texture and flavors to the products that uses the particular processed cocoa powder.

Cocoa powder has polyphenols which are naturally occurring antioxidants, flavanols in cocoa powder improve nitric oxide levels in the blood which leads to lower blood pressure, furthermore the polyphenols and flavanols in cocoa powder have been shown to reduce stroke and heart attacks while improving blood flow to the brain. Cocoa powder has chemical substances theobromine (hence the name Theobroma) and related theophylline, which have anti-inflammatory activities.

Cocoa powder contains bitter tasting compounds such as alkaloids including caffeine and theobromine. Cocoa powder also contains clovamide (N-caffeoyl-L-DOPA).

The cacao butter and cocoa power ingredients are blended with sugars, milk, milk solids, surfactants, oils, emulsifiers, and flavors to yield the chocolate. Chocolate serves as a base for candies, cakes, cookies and other sweet dessert items.

There are numerous attempts incorporating additional caffeine into cocoa-based products such as chocolates. However, because of the bitter tastes from caffeine and the inherent bitter taste of cocoa products, the amount of caffeine that can be incorporate into chocolate compositions have been very limited so far.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

In one aspect, the application provides highly caffeinated cocoa-based composition. In one embodiment, the composition includes a cocoa component comprising cocoa powder or extract, a caffeinated component comprising caffeine, a complexing component, a fat component and a sweetening component. The complexing component may be configured to reduce the bitterness of the high caffeine cocoa-based composition by complexing with the caffeinated component, the cocoa component, or both.

In one embodiment, the caffeinated component comprises caffeine, green coffee bean powder or extract, green tea powder or extract, white tea powder or extract, black tea powder or extract, guarana powder or extract, verba mate powder or extract, cola nut powder or extract, coffee powder or extract, or a combination thereof. In one embodiment, the caffeinated component comprises a plant extract or powder containing at least 10% of caffeine.

The caffeinated component may further comprise additional stimulants or nootropics. Examples include without limitation vitamin Bs, tyrosin, tryptophan, histidine, arginine, L-theanine, creatine, acetyl-L-carnitine, 2-dimethylaminoethanol (DMAE), Ginkgo biloba, or a combination thereof.

The composition may include from about 0.5% to about 5% caffeine. In one embodiment, the composition includes not less than 0.8% caffeine. In one embodiment, the composition includes from about 1% to about 2% of caffeine. In one embodiment, the composition includes about 1.5% caffeine. In one embodiment, the highly caffeinated cocoa-based composition may include at least 0.8%, 0.9% or 1% caffeine by weight. In one embodiment, the highly caffeinated cocoa-based composition comprises at least 1.5%, 2%, 2.5% or 3% caffeine by weight.

In one embodiment, the cocoa component comprises cacao powder, cocoa liquor, extract, derivatives or a combination thereof. In one embodiment, the cocoa component comprises alkaloids such as theobromine, polyphenol, flavonoids, amino acids, or a combination thereof.

The composition may include from about 20% to about 90% the cocoa component. In one embodiment, the composition may include not less than 20% the cocoa component. In one embodiment, the composition may include from about 20%, 25%, 30%, 35%, 40%, 45%, 50%, 55%, 60%, 65%, 70%, 75%, 80%, or 90% of the cocoa component. In on embodiment, the composition may include from about 20% to about 36% of the cocoa component.

In one embodiment, the complexing component may be configured to complexing with the caffeinated component, the cocoa component, or both to form a complex therefore reducing the bitterness of the high caffeinated cocoa-based composition. In one embodiment, the complexing may be through coordinating, chelating, complexing, hydrogen-bonding, dipole-dipole interaction, van-der waals interaction, electrostatic interaction, or a combination thereof.

In one embodiment, the complexing component comprises nucleic acid, plant powder such as nucleic acid rich fruit power, protein, peptide, cluster dextrin, cyclodextrin, polydextrose, polyethylene glycol, fatty acids, waxes, zeolite, chitosan, poly N-acetylglucosamine, N-acetylglucosamine, or a combination thereof. In one embodiment, the complexing component is configured to complex with caffeine. In one embodiment, the complexing component is configured to complex with theobromine, polyphenol, flavonoids, or a combination thereof.

In one embodiment, the highly caffeinated cocoa-based composition comprises at least 0.5% of the complexing component by weight. In one embodiment, the composition comprises at least 12% of the complexing component by weight. In one embodiment, the complexing component comprises cyclodextrin and the highly caffeinated cocoa-based composition comprises at least 0.2%, 0.3%, 0.5%, 0.8%, 1%, 1.5%, or 2% of cyclodextrin. In one embodiment, the complexing component comprises strawberry powder and wherein the highly caffeinated cocoa-based composition comprises at least 0.2%, 0.25%, 0.5%, 0.8%, 1% or 2% of nucleic acid rich strawberry powder. In one embodiment, the composition comprises from about 2% to about 5% by weight the complexing component.

In one embodiment, the sweetening component may comprise conventional sugar, sugar alcohol, sugar substitute, or sugar substitutes. In one embodiment, the sweetening component comprises erythritol, xylitol, sucrose, fructose, glucose, maltose, trulinose, juice or juice concentrate, hydrogenated starch hydrolysates, invert sugar, artificial sweeteners, saccharin, saccharin salts, cyclamic acid, cyclamic acid salts, aspartame, sucralose, acesulfame, rebaudioside A, rebaudioside B, rebaudioside C, rebaudioside D, rebaudioside E, dulcoside A, dulcoside B, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, acesulfame potassium and other salts, aspartame, alitame, saccharin, neohesperidin dihydrochalcone, cyclamate, neotame, N-[N-[3-(3-hydroxy-4-methoxyphenyl)propyl]-L-.alpha.-aspartyl]-L-phenylalanine 1-methyl ester, N-[N-[3-(3-hydroxy-4-methoxyphenyl)-3-methylbutyl]-L-alpha-aspartyl]-L-phenylalanine 1-methyl ester, N-[N-[3-(3-methoxy-4-hydroxyphenyl)propyl]-L-alpha-aspartyl]-L-phenylal-anine 1-methyl ester, salts thereof, licorice or its extracts or isolates, or a mixture thereof.

In one embodiment, the sweetening component consists essentially of sucrose, glucose, and fructose. In one embodiment, the sweetening component consists essentially of sugar alcohols. In one embodiment, the sweetening component comprises erythritol, xylitol, mannitol, sorbitol, isomalt, maltitol, lactitol, hydrogenated starch hydrolysates, or a combination thereof. In one embodiment, the sweetening component consists essentially of sugar substitutes. In one embodiment, the sweetening composition comprises essentially trehalose, palatinose, psicose, tagatose, sorbose, or a combination thereof.

The composition may include not less than 10% by weight of the sweetening component. In one embodiment, the composition comprises from about 20% to about 40% by weight of the sweetening component. In one embodiment, the composition comprises from about 10% to about 50% by weight of the sweetening component.

The highly caffeinated cocoa-based composition may have a low or zero glycemic index. In one embodiment, the composition is sugar free. In one embodiment, the composition may have a glycemic index of not more than 30, 25, 20, 15, 8, 5, 1, or any other number in between.

The fat component may comprise any food grade fat. In one embodiment, the fat component comprises an animal fat, a plant fat, or a combination thereof. In one embodiment, the fat component comprises lard, milk fat, coconut fat, palm fat, palm kernel fat, cocoa butter, or a combination thereof. In one embodiment, the fat may be high melting fat such as cocoa butter fat. In one embodiment, the fat may be low melting fat such as coconut oil, avocado oil, grape seed oil, vegetable oil, olive oil, or a combination thereof. In one embodiment, the fat may be a saturated fat. In one embodiment, the fat may be an unsaturated fat. The fat component may comprise a fat having a melting point from about 34 C to about 38 C. In one embodiment, the fat component may comprise essentially oil. Example essential oil include, without limitation, lemon oil, orange oil, rose oil, lavender oil, chamomile oil, rosemary oil, mint oil, clove oil, or a combination thereof.

The composition may include not less than 10% of the fat component. In one embodiment, the composition includes from about 20% to about 50% by weight the fat component. In one embodiment, the composition comprises from about 30% to about 40% by weight of the fat component.

The highly caffeinated cocoa-based composition may further include a surfactant component, an antioxidant composition, a vitamin composition, a mineral composition, an amino acid composition, a synergistic composition, an herb composition, a prebiotic composition, a probiotic composition, or a combination thereof.

In one embodiment, the composition comprises from about 0.01% to about 1% by weight of the surfactant component. In one embodiment, the composition comprises from about 0.1% to about 0.5% by weight of the surfactant (or emulsifier) component. In one embodiment, the surfactant/emulsifier may include, without limitation, a phospholipid emulsifier such as soy lecithin, a polyglycerol polyricinoleate (PGPR) such as a surfactant commercially available as Admul WOL.

In one embodiment, the antioxidant composition comprises vitamin A, vitamin E, vitamin C, beta-carotene, alpha-carotene, lycopene, lutein, folic acid, gallic acid, resveratrol, quinone, Coenzyme Q10, selenium, selenium yeast, phenolics, polyphenols, anthocyanins, flavonoids, astaxanthin, canthaxanthin, cryptoxanthin, anthracenes, carotenoids, zeaxanthin, curcumin, glutathione, fruit extracts, or derivatives thereof. In one embodiment, the vitamin composition comprises vitamin A, B, C, D, E, K or a combination thereof. In one embodiment, the mineral composition comprises salts of calcium, iron, zinc, magnesium, sodium, chloride, potassium, copper, molybdenum, manganese, phosphorus, iodine, nickel, or selenium, or a combination thereof. In one embodiment, the amino acid composition comprises an essential amino acid, a branch-chain amino acid, a stimulant amino acid, or its derivative thereof.

In one embodiment, the synergistic composition comprises magnesium, L-theanine, theothromine, piraletam, citicoline, flavonoids, quinones, blubbery extract or isolates, arginine, vitamin E, bacopa, curcumin, ginseng, citrulline, icariin, forskin, S-denosyl-L-methionine, quercetine, taurine, salvia, Ginkgo biloba, ferulic acid, liquiritin, magnolol, and ginsenoside Rb2, Borneol, ginsenoside Rc, artemisinin, chenodeoxycholic acid, daidzin, and bacopaside I, carthamus (honghua), peony root, condonopsis, or isolates, extracts or derivatives thereof. The synergistic composition may be configured to enhance caffeine's stimulant effect or reduce its jittery anxiolysis, and cardiovascular side effects.

In one embodiment, the herbal composition comprises ginko biloba, turmeric, ginger, astragalus, Prunella vulgaris, Pueraria montana var. lobata, Salvia miltiorrhiza, Coptis chinensis, Eucommia ulmoides Oliver, cranberry, blackberry, elderberry extract, blueberry, grapeseed, saffron, Sangre de grado (dragon's blood), hemp, cannabidiol, bacopa monnieri, Rhodiola rosea, Panax Ginseng, nicotine, acylprolyldipeptide, piracetam, phenylpiracetam, huperzine-A, Huperzia seratta extract or powder, Ashwagandha, Gotu Kola, Lemon Balm, its extract, powder or derivative thereof.

In one embodiment, the prebiotic composition comprises gum arabic, xanthan gum, locust bean gum, guar gum, glucan, galactoglucan, mannan, chicory root, wheat bran, resistant starch, mannose oligosaccharide, acacia gum, inulin, galacto-oligosaccahride, guar gum, Artichoke fiber, fructo-ligosaccharide, or a combination thereof.

The probiotic composition comprises bifidobacteria, lactic acid bacteria, or a combination thereof. In one embodiment, the probiotic composition comprises Bifidobacterium lactis, Bifidobacterium longum, Lactobacillus acidophilus, Lactobacillus paracasei, Lactobacillus plantarum, Lactobacillus rhamnosus, Bacillus coagulans, Bifidobacterium bifidum, Lactobaccillus casei, Lactobaccillus gasseri, Lactobacillus salivarius, Lactobacillus bulgarius, or a combination thereof.

The highly caffeinated cocoa-based composition may further include an additive selected from food acids, flavoring agents, coloring agents, humectants, bulking agents, fatty acids, triglycerides, plasticizers, emulsifiers or surfactants, thickeners, preservatives, or and a mixture thereof.

In one embodiment, the flavoring agent comprises vanilla, chili oil, gingerol, peperine, capsaicin, peppermint oil, spearmint oil, eucalyptus oil, cinnamon oil, grapefruit oil, menthol, mono-menthyl succinate, menthol ethylene glycol carbonate, menthone glycerol ketal, menthyl lactate, (−)-isopulegol, p-menthane-3, 8-diols, (−)-monomenthyl glutarate, oil of wintergreen (methylsalicylate), citrus oils, orange oils, fruit essences, rosemary oil, lavender oil, sage oil, clary sage oil, thyme oil, sandalwood oil, basil oil, coriander oil, cypress oil, fleabane oil, frankincense oil, geranium oil, fennel oil, oregano oil, Dalmatian sage oil, tarragon oil, cocoa, pineapple flavor, or mixtures or derivatives thereof.

In a further aspect, the application provides methods for making the highly caffeinated cocoa-based composition.

In an additional aspect, the application provides methods for reducing bitterness of a highly caffeinated cocoa-based composition.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1 shows the chemical structures of example alkaloids, flavonoids and amino acids in cacao products;

FIG. 2 shows the representative nucleic acid base pair structure;

FIG. 3 shows representative nucleic acid complexing with theobromine, a main bitter tasting component in cocoa products;

FIG. 4 shows the simplified structure of cluster dextrin. Cluster dextrin has a ring structure with pendent chains of glucose. Cluster dextrin tends to form helical structures, which are good for chelating the volatile compounds found in chocolate;

FIG. 5 shows the chemical structure of alpha-, beta- and gamma-cyclodextrin molecules;

FIG. 6 shows the hydrophobic interior cavity of the cyclodextrin complex with a representative hydrophobic bitter tasting compound found in cocoa to form an inclusion complex; and

FIG. 7 shows the ring structure of the cyclodextrin coordination of a flavonoid molecule, in which the interior of the cyclodextrin is able to electronically interact with the phenyl groups of the flavonoid molecule; the phenyl group is a reverse quadrapole where the interior of the aromatic ring is very high in electron density and the exterior of the ring is electron deficient; the interior of the CD cavity is mostly the carbon atoms of the carbohydrate and the oxygen atoms are primarily on the exterior; oxygen atoms, being more electonegative than carbon atoms, withdraw electron density from carbon atoms; and this makes the carbon atoms attract to the aromatic rings of the polyphenol or flavonoid molecule.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The application provides highly caffeinated cocoa-based composition that contains a percentage of caffeine not less than about 0.8%. In one embodiment, the application provides highly caffeinated cocoa-based composition that contains high percentage of caffeine without the significant bitterness. In one embodiment, the composition contains at least 1% of caffeine. In one embodiment, the composition contains at least 1.2%, 1.3%, 1.5%, 1.6%, 1.7%, 1.8%, 2%, 2.5%, or 3% of caffeine.

Cocoa includes many active chemical compounds. Some of these chemical compounds are bitter in taste including, for example, theobromine, flavonoids, polyphenols, and xanthine derivatives. All these compounds contribute to the bitter taste of cocoa.

Cacao seeds and powders are a rich source of polyphenols (about 15% of dry bean weight). These compounds confer astringent and bitter sensations and contribute to the green and fruity flavors of cocoa liquors. Flavonoids include (−)-epicatechin (the major flavanol present in unroasted cocoa beans) and roasting introduces (−)-catechin, and (+)-epicatechin. The polyphenol and flavonoid compounds impart astringent sensations and bitter tastes to cocoa-based products.

Cocoa powder also contains a number of amino acids. Example amino acids include alanine, valine, leucine, tyrosine, and phenylalanine. The amino acids may impart a variety of flavors to cocoa; however, the dominant flavor is bitterness. For example, phenylalanine is strongly bitter whereas valine and leucine are bitter.

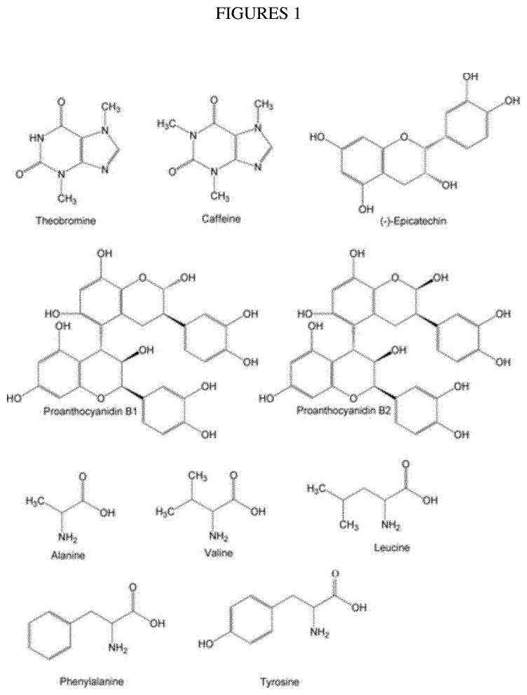

Cocoa powder additionally contains a significant concentration of alkaloids. Raw cacao beans contain about 4% by weight methyl xanthine. Theobromine (3,7-dimethylxanthine) is the major alkaloid of cocoa (2% to 3%). Caffeine (1,3,7-trimethylxanthine) is found only in small amounts (0.2%), and theophylline as traces (Franco and others 2013). They all contribute to the bitter taste of cocoa. The chemical structures of some alkaloids, flavonoids and amino acids from cocoa products are shown in FIG. 1.

In one embodiment, the disclosure provides compositions and methods of masking the naturally occurring bitter compounds in the cocoa or chocolate products, masking the bitterness from caffeine in the caffeinated cocoa-based composition, or both. The result would be the reduced overall bitterness of the highly caffeinated cocoa-based or chocolate products with caffeine incorporated therein.

In one aspect, the application provides a highly caffeinated cocoa-based composition. In one embodiment, the comprises a cocoa component.

The main component to chocolate is cocoa powder or cocoa liquor, which gives the color and flavor to chocolate. The cocoa powder and the cocoa liquor are the main source for polyphenols, flavonoids, and alkaloids found in chocolate. Example alkaloids include theobromine. There several different processing techniques those yield cocoa products from cacao beans. The main two are natural process and Dutch process cocoa. Natural process cocoa powder has a light brown color and an extractable pH of 5.3 to 5.8. The Dutch processed (alkalized) cocoa powder is darker in color, ranging from brownish red to nearly black, with a pH from 6.8 to 8.1. The alkalization process reduces bitterness and improves solubility.

In one embodiment, the composition comprises from about 10% to about 50% of cocoa powder or liquor. In one embodiment, the composition comprises from about 10-20%, 25-45%, 15%-30%, 35-50% of cocoa powder or liquor.

In one embodiment, the composition comprises a caffeinated component comprising caffeine. In one embodiment, the highly caffeinated cocoa-based composition comprises a complexing component. In one embodiment, the complexing component is configured to reduce the bitterness of the composition by complexing with the bitter tasting components in the composition. The bitter tasting components may be in the caffeinated component, the cocoa-based component, or both. Example bitter tasting compounds that could be complexed by the complexing component include caffeine, theobromine, polyphenols, amino acids, flavonoids, or other alkaloids.

In one embodiment, caffeine may be natural, synthetic, or a combination thereof. In one embodiment, the caffeinated component consists essentially of caffeine

In one embodiment, the caffeinated component comprises a caffeine-containing plant extract or powder. In one embodiment, the caffeine-containing plant extract or powder may contain caffeine at a concentration of at least 3%, 5%, 8%, 10%, 20%, 40%, 50%, 60%, 70%, 80%, 90%, 98%, or 99%. In one embodiment, the caffeine-containing plant extract or powder may be green coffee bean powder or extract, green tea powder or extract, white tea powder or extract, black tea powder or extract, guarana powder or extract, yerba mate powder or extract, cola nut powder or extract, coffee powder or extract, or a combination thereof.

In one embodiment, the highly caffeinated cocoa-based composition consists essentially of caffeine, cocoa powder or extract, a complexing component, a fat component and a sweetening component. In one embodiment, caffeine and cocoa powder or extract has a ratio from about 1-part caffeine to 2-parts cocoa to about 1-part caffeine to 10-parts cocoa, from about 1-part caffeine to 3-parts of coca to about 1-part caffeine to 5-parts of cocoa.

In one embodiment, the caffeinated component comprises caffeine, guarana powder or extract, or a combination thereof. In one embodiment, the caffeinated component consists essentially of guarana powder or extract. In one embodiment, the guarana powder or extract contains at least 4%, 8%, 10%, 30%, 50%, 80%, 95%, 98% or 99% of caffeine.

In one embodiment, the caffeinated component comprises coffee powder or extract. In one embodiment, the coffee powder or extract contains about 3%, 4%, 8%, 10%, 30%, 50%, 80%, 95%, 98% or 99% of caffeine.

In one embodiment, the caffeinated component comprises green tea powder or extract. In one embodiment, the green tea powder or extract contains about 3%, 4%, 8%, or 10% of caffeine.

The complexing component is capable of interacting with bitter tasting compounds in the highly caffeinated cocoa-based composition through coordinating, chelating, complexing, hydrogen-bonding, dipole-dipole interaction, van-der Waals interaction, electrostatic interaction, or a combination thereof. Through complexing with the bitter tasting compounds, the complexing component acts to reduce the bitterness of the composition.

In one embodiment, the complexing component may contain polymeric molecules having a MW of at least 30 kDa. The polymeric molecule may possess tertiary structure capable of complexing with or fitting the bitter tasting component into the structure through hydrogen-bonding, dipole-dipole interaction, van-der Waals interaction, or a combination thereof.

In one embodiment, the complexing component is configured to complex with caffeine. In one embodiment, the complexing component is configured to complex with theobromine, polyphenol, flavonoids, amino acids, or a combination thereof.

In one embodiment, the complexing component contains nucleic acid, plant powder or fruit power, protein, peptide, cluster dextrin, any derivative of cyclodextrin, polydextrose, polyethylene glycol, fatty acids, waxes, zeolite, chitosan, poly N-acetylglucosamine, N-acetylglucosamine, or a combination thereof. In one embodiment, the complexing component comprises DNA, RNA, protein, peptide, resistant starch, porphyrin, polyunsaturated hydrocarbons, polyunsaturated fatty acids, mica, talc, zeolite, silica, cellulose, lignin, plant particles, MOF, calcium carbonate, diatomaceous earth, or a combination thereof.

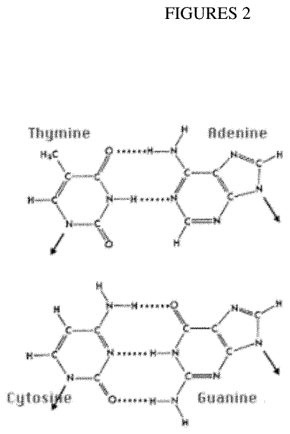

Nucleic acid may be DNA, RNA, or a combination thereof and can be either extracted from various lifeforms or synthetic. In one embodiment, nucleic acid may have a molecule weight from about 0.2 kDa to about 1000 kDa. Examples of nucleic acids include adenine, cytosine, guanine, thymine, and uracil that can be in either polymeric or monomeric form. DNA is made of base pairs that associate with each other through hydrogen bonding. These base pairs are adenine, cytosine, guanine and thymine. Adenine and Guanine structures are related to the xanthine structure (caffeine, theobromine). The base pairs are shown in FIG. 2.

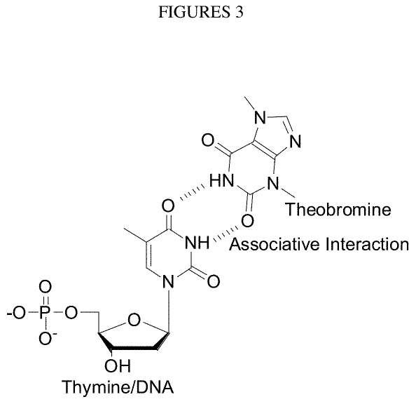

Not wanting to be limited by theory, through hydrogen-bonding or dipole-dipole interaction, thymine and guanine can bind with the xanthine derivatives such as caffeine and theobromine. When the DNA binds to caffeine and theobromine the bitterness of chocolate is reduced. As an example, the binding mechanism is shown in FIG. 3.

Not all species have the same amount of DNA. Vegetation can be particularly high in DNA content. For example, cannabis has about 30,000; the lotus has ˜40,000; soybean 46,000; apple trees 57,000; and the poplar tree ˜45,000 according to one source and 73,000 according to another. The reason for the large amount of DNA in plants is that gene duplication and retention of the duplicates is more common in plant evolution than in animals, This is especially true for strawberries which has 8 duplicates of each gene leading to 700-800,000 genes.

The high DNA content in plants make their flesh particularly useful in reducing bitterness imparted by the alkaloids. For example, the more DNA content the more available base pairs to bind the caffeine or theobromine. There are a number of plant matters that may be useful to help reduce bitterness including, for example, the fruit powders may be berries such as strawberry, raspberry, blueberry, black berry, acai berry, elderberry, goji berry, cherry, cranberry, marionberry, and the like; fruits such as apple, orange pulp, cantaloupe, melon, apple, date, jujube, pear, peach, dragon fruit, star fruit, pineapple, and the like; spice powders such as cinnamon, nutmeg, cloves, licorice, ginger, and the like; herbals such as basil, oregano, chili, jalapeno, habanero, bay, chives, dill, and the like; and fungi such as mushrooms, chanterelles, truffles, oyster mushroom, mica cap and the like.

In one embodiment, the complexing component may include nuclide acid rich fruit powders. Representative fruit powder may include strawberry powder, orange pulp or peel powder, lemon pulp or peel powder, citrus fruit powder, apple powder, pineapple powder, baobab fruit powder, various berry powders including without limitation cherry powder, raspberry powder, blackberry powder, goji berry powder, asci fruit powder, cashew false fruit powder, monk fruit powder, dragon fruit powder, passion fruit powder, coconut powder, guava powder, cranberry powder or blueberry powder.

In one embodiment, the highly caffeinated cocoa-based composition comprises at least 0.035%, 0.05%, or 0.1%, 0.2%, 0.3% of strawberry powder. In one embodiment, the composition comprises at least 0.050%, 0.1%, 0.2%, or 0.3% of comprises orange peel or pulp powder. In one embodiment, the composition comprises at least 0.05%, 0.1%, 0.2%, or 0.3% of lemon peel or pulp powder. In one embodiment, the composition comprises at least 0.065%, 0.1%, 0.1%, 0.3%, 0.4%, 0.5%, 0.75%, 1%, or 2% of goji berry powder.

In one embodiment, the composition has a ratio of caffeine to fruit powder from about 3:1 to about 1:15. In one embodiment, the ratio is from about 2:1 to about 1:10, from about 1:1 to about 1:8, from about 2:1 to about 1:6, from about 1:1 to about 1:5. In one embodiments, the ratio is about 3:1, 2:1, 1:2: 1:1, 1:3, 1:4, 1:5, 1:6, 1:7, or 1:8.

In one embodiment, the complexing component comprises a nucleic acid molecule or nucleic acid rich fruit powder. In one embodiment, the nucleic acid molecule may be a DNA molecule. The DNA molecule may form a DNA-caffeine complex therefore reducing or modulating the bitterness of caffeine. In one embodiment, the DNA-caffeine complex may have an arrangement in which the caffeine molecule is complexed with DNA double helix with an orientation parallel to the bases. In one embodiment, the caffeine molecule complexes with DNA double helix through hydrogen-bonding. In one embodiment, the complexing component comprises DNA molecules from plant source.

Caffeine is similar in structure to DNA and RNA base pairs. Without being limited by theory, being similar in structure and functionality, the caffeine molecule is able to hydrogen bond with the base pairs to form a DNA-caffeine complex. The complex helps to reduce or mask the bitterness of the caffeine.

Protein or peptide may have a MW from about 0.5 kda to about 1000 kda. In one embodiment, the peptide may be polylysine. In embodiment, the peptide may have MW of not more than 30 kDa. In one embodiment, the peptide may include FVDVT, AGPHGPPGKDGR, D4E1, GLP-1, collagen, or a combination thereof.

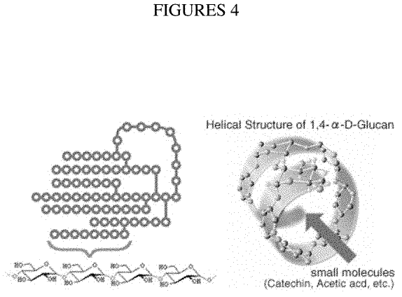

In one embodiment, the complexing component may include cluster dextrin. Polymers of the saccharides can exist in a variety of forms. Some of the forms of polymeric saccharides are cyclic ring structures. The cyclic polymers of the saccharides can exist in several different forms. The ring structures can be highly branched and are often called cluster dextrin. A simplified structure of a cluster dextrin is shown in FIG. 4. Cluster dextrin compounds have a ring structure with many branches of long chains of glucose units pendent to the ring. This has the effect of forming a helical structure. The helical structure and the ring structure of cluster dextrin molecules are both able to chelate small molecules. The helical structure and the ring structure of cluster dextrin are both able to chelate volatile molecules found in chocolate. The chelation takes place by the long chain (hexyl, octyl and so on) derivative molecules fitting inside the helical structure.

In one embodiment, cluster dextrin may have a MW from about 1 kDa to about 400 kDa. In one embodiment, the complexing component comprises cluster dextrin and the highly caffeinated cocoa-based composition comprises at least 0.01% of cluster dextrin and up to 25% of cluster dextrin.

In one embodiment, the complexing component may include cyclodextrin. Cyclodextrin may be alpha, beta, or gamma. In one embodiment, cyclodextrin may have a MW from about 950 g mol-1 to about 3400 g mol-1. In one embodiment, the highly caffeinated cocoa-based composition comprises at least 0.01% of cyclodextrin and up to 25% of cyclodextrin. In one embodiment, cyclodextrin comprises alpha, beta, gamma-cyclodextrin or a combination thereof. In one embodiment, the complexing component comprises alpha-cyclodextrin, beta-cyclodextrin, gamma-cyclodextrin, or a combination thereof. In one embodiment, the complexing component consists essentially of alpha-cyclodextrin. In one embodiment, the complexing component consists essentially of beta-cyclodextrin. In one embodiment, the complexing component consists essentially of gamma-cyclodextrin. In one embodiment, the composition comprises at least 3.5% of gamma-cyclodextrin.

Cyclodextrins (sometimes called cycloamyloses) are a family of compounds comprising of sugar molecules bound together in a ring (cyclic oligosaccharides). Cyclodextrins are composed of 5 or more α-D-glucopyranoside units linked 1->4. Typical cyclodextrins contain a number of glucose monomers ranging from six to eight units in a ring, creating a cone shape. The largest cyclodextrin contains 32 units of 1,4-anhydroglucopyranoside.

Cyclodextrin molecules may have substitution on the ring of α-D-glucopyranoside units. Some examples of moiety substitution on the ring of α-D-glucopyranoside units include hydroxypropyl, methyl, ethyl, acetyl, butyrate, iodo, amino, azido, carboxymethyl and the like. Substitution upon the α-D-glucopyranoside units can modify the interior cavity of the cyclodextrin.

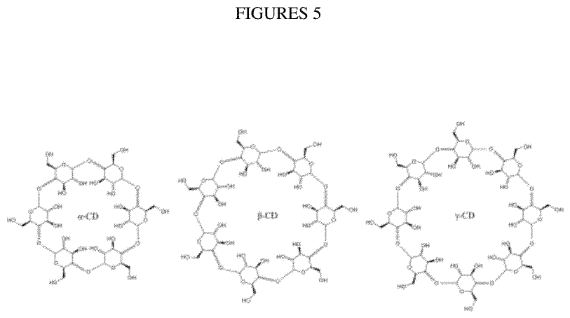

α (alpha)-cyclodextrin is a 6-membered sugar ring molecule. β (beta)-cyclodextrin is a 7-membered sugar ring molecule. γ (gamma)-cyclodextrin is a 8-membered sugar ring molecule. The interior of the cyclodextrin, be it alpha, beta or gamma, is extraordinarily hydrophobic while the exterior of the cyclodextrin is hydrophilic. FIG. 5 shows the structure of various cyclodextrin molecules.

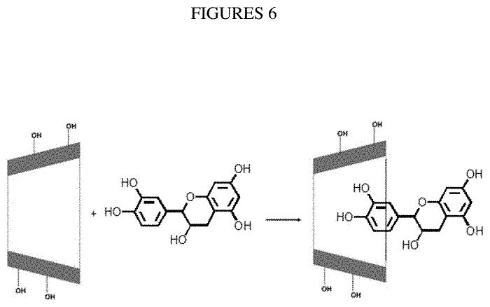

In one embodiment, the complexing component comprises alpha-cyclodextrin. Alpha cyclodextrin consists of a ring of 6 glucose units while beta has 7 glucose units in a ring and gamma has 8 glucose units in a ring. The ring structures form a crown. The inside of the crown is hydrophobic whereas the exterior is hydrophilic. The cavity of the cyclodextrin is able to chelate small hydrophobic molecules. The cyclodextrin molecules may form inclusion complex with hydrophobic bitter tasting molecules. In one embodiment, the bitter tasting compounds are complexed inside the cone shape of the cyclodextrin molecule, therefore shields bitter taste. FIG. 6 shows the interior cavity of the cyclodextrin, which is hydrophobic. The hydrophobic interior cavity allows the cyclodextrin to capture bitter tasting compounds that are hydrophobic. The hydrophobic cavity of the cyclodextrin allows for formation of inclusion complexes between a bittering agent and cyclodextrin which removes the bitter taste imparted by the bittering agent. The inclusion complexes allow for more actives, such as caffeine, to be added without impacting overall bitterness levels of the highly caffeinated cocoa-based composition.

In one embodiment, the composition may have a caffeine and cyclodextrin ratio from about 5:1 to about 1:15. In one embodiment, the ratio may be 3:1 to 5:1, 2:1 to 1:2, 1:1 to 1:5, 2:1 to 1:8, 3:1 to 1:10, 1:4 to 1:6, 1:3 to 1:7, 1:2 to 1:6, or any ratio in between. In one embodiment, the ratio may be 1:10, 1:7, 1:6.5, 1:6, 1:5.5, 1:5, 1:4.5, 1:4, 1:3.5, 1.3, 1:2, 1:1, or any ratio in between.

In one embodiment, the composition may have a cocoa and cyclodextrin ratio from about 1:1 to 20:1, 1:1 to 15:1, 2:1 to 10:1, 1:1 to 5:1, 2:1 to 8:1, 1:1 to 4:1, 2:1 to 5:1, or any ratio in between. In one embodiment, the ratio may be 1:1, 1.8:1, 2:1, 2.2:1, 3:1, 3.6:1, 4:1, 4.3:1, 5:1, 5.5:1, 6:1, 6.2:1, 7:1, 7.4:1, 8:1, or any ratio in between.

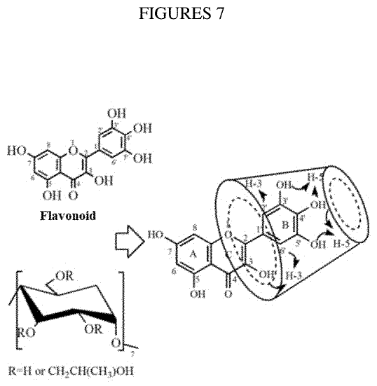

In one embodiment, the complexing component may comprise cyclodextrin and a biophenol. The biophenol may form complex with cyclodextrin and caffeine. In one embodiment, the biphenol-caffein-cyclodextrin complex may be more stable than caffeine-cyclodextrin complex. In one embodiment, the biophenol comprises tyrosol, oleuropein, or a combination thereof. In one embodiment, the biophenol comprises polyphenols such as flavonoids. FIG. 7 shows the process of chelation of polyphenol or flavonoid molecule from chocolate. The formation of the chelate structure is endothermically favorable due to electrostatic interactions of the pi system of the aromatic moiety with the hydroxyl groups. It is these electronic interactions between the hydroxyl moieties of the cyclodextrin and the pi system that gives the favorable heat of formation.

The alpha, beta, and gamma cyclodextrins do not form the complex with compounds in chocolate equally. The application further provides methods for preparing and forming the novel inclusion complexes. In one embodiment, such complexes are made by dissolving cocoa powder or chocolate in a selected cyclodextrin. The product is usually a mixture of polyphenol or flavonoid derivative/cyclodextrin-complex, uncomplexed polyphenol derivative and uncomplexed cyclodextrin. The complexation constant between polyphenol/flavonoid derivatives and cyclodextrin varies. The complexation constant (K1:1, K1:2) between polyphenol/flavonoid derivative and cyclodextrin s are usually in a range of 800 M⁻¹ to 3000 M⁻¹ The body's ability to digest the cyclodextrin will be taken into account as well. FDA sets limits on how much cyclodextrin can be used in a product. Alpha-cyclodextrin is limited to 3% of the product weight, beta-cyclodextrin is limited to 50 mg/kg, while there is no limit to gamma-cyclodextrin. For example, beta-cyclodextrin may give the strongest stability constants followed by gamma.

The complexing component may include plant particles or powder. In one embodiment, the plant particles are derived from husk, seed, seed shell, nut, nut shell, fruit, flower, stem, leaf, rice husk, nut shell, woody root, stem or leaves, corn husk, oat husk, grain husk, yeast, mushroom, berry seed, raspberry seed, blackberry seed, blueberry seed, strawberry fruit, chili, pepper, or a combination thereof. In one embodiment, the plant particles comprised defatted berry seed particles. In one embodiment, the plant particles have a particle size from about at least 70 mesh. In one embodiment, the plant particle has a particle size from about 70 to about 200 mesh. In one embodiment, the plant particle has a particle size of not greater than about 200 mesh.

The highly caffeinated cocoa-based composition may include at least 0.01% of the complexing component by weight. In one embodiment, the composition may include from about 0.5% to about 10.0% the complexing component by weight. In one embodiment, the composition may include at least 1%, or up to 12% of the complexing component by weight.

In one embodiment, the molar ration of complexing component and the caffeinated component may be from about 1:1 to about 100:1, or any ratio in between. In one embodiment, the molar ration of complexing component and the caffeinate component is at least 1:1, 2:1, 5:1, 10:1, 100:1, or any ratio in between.

In one embodiment, the highly caffeinated cocoa-based composition may further include a flavor masking agent. In one embodiment, the flavor-masking agent may be a sugar alcohol. Sugar alcohols can mask certain flavors. For example, mannitol is a sugar-alcohol derived from the aldose called mannose. Mannitol can help mask bitterness. Mannitol masks bitterness by a mechanism that involves the endothermic nature of mannitol dissolving into water. In one embodiment, the flavor-masking agent may be taurine. Taurine, or 2-aminoethanesulfonic acid, is an organic compound that is widely distributed in animal tissues. It is a major constituent of bile and can be found in the large intestine, and accounts for up to 0.1% of total human body weight. Taurine can reduce bitterness by 50% when added at a concentration of 300 mM.

The highly caffeinated cocoa-based composition can contain surprisingly high concentration of caffeine without the taste of caffeine's bitterness. Caffeine content may include a total amount of caffeine and the caffeine content from the plant powder or extract. In one embodiment, the composition may contain from about 0.8% to about 10% of caffeine. In one embodiment, the composition comprises at least 1%, 1.5%, 2%, 2.5%, 3%, 3.5% or 4% caffeine by weight. The weight percentage of caffeine may be any number in between the ranges.

In one embodiment, the composition comprises at least 0.8% caffeine by weight. In one embodiment, the highly caffeinated cocoa-based composition comprises at least 1%, 1.5%, 2%, 2.5%, 3%, 3.5% caffeine by weight, or any percentage in between. In one embodiment, the composition contains about 0.5%, 0.6%, 0.7%, 1.1%, 1.3% or 1.5% caffeine by weight.

In one embodiment, the composition may include a fat component. Useful fat may include cocoa butter, coconut oil, milk fat, or other vegetable or essential oils.

Cacao butter is the oil from the Theobroma cacao beans. The oil is separated from the beans during processing the beans to cocoa powder. Cacao butter is a higher melting fat with a melting point of around 34-38° C. (93-101° F.).

Milk fat may be used to make both milk and dark chocolates flavored cocoa composition. Milkfat has crystallization properties that are compatible with cacao butter. Milk fat can help prevent blooming of the cocoa composition. Milk fat also helps to modify the hardness and texture of the composition. Milk fat can also help to mellow the bitterness of cocoa composition and increase the sweetness.

Coconut oil has a slightly lower melting point than cacao butter (depending upon how refined) and can lower the hardness and melting point of the chocolate product. Palm kernel oil has a higher melting point than cacao butter and the resulting chocolate products are harder in texture and have higher melting points.

In one embodiment, the fat composition may include triglycerides, fatty acids, or oils, which may be saturated or unsaturated. Example triglycerides, fatty acids, or oils include without limitation coconut oil or fat, palm oil or fat, cocoa butter, shea butter, lard, milk fat, linseed oil, flax seed oil, hemp oil, safflower oil, cotton seed oil, avocado oil, grape seed oil, olive oil and the like.

In one embodiment, triglycerides, fatty acids, or oils may include wax. Waxes may be carnauba wax, bee's wax, paraffin wax, rice bran wax, sugar cane wax, shellac, or resin or any combination.

The highly caffeinated cocoa-based composition may further comprise an antioxidant composition, a vitamin composition, a mineral composition, an amino acid composition, a synergistic composition, an herb composition, or a combination thereof.

In one embodiment, the antioxidant composition comprises wherein the antioxidant composition comprises vitamin A, vitamin E, vitamin C, beta-carotene, alpha-carotene, lycopene, lutein, folic acid, gallic acid, resveratrol, quinone, Coenzyme Q10, selenium, selenium yeast, phenolics, polyphenols, anthocyanins, flavonoids, astaxanthin, canthaxanthin, cryptoxanthin, anthracenes, carotenoids, zeaxanthin, curcumin, or derivatives thereof.

In one embodiment, the vitamin composition comprises vitamin A, B, C, D, E, K or a combination thereof. In one embodiment, vitamin B comprises thiamin (B1), riboflavin (B2), niacin or niacinamide (B3), pantothenic acid (B5), pyridoxines (B6), biotin (B7), folate or folic acid (B9), cobalamin (B12), or their derivative thereof.

In one embodiment, the mineral composition comprises salts of calcium, iron, zinc, magnesium, sodium, chloride, potassium, copper, molybdenum, manganese, phosphorus, iodine, nickel, or selenium, or a combination thereof.

In one embodiment, the amino acid composition comprises an essential amino acid or its derivative thereof. In one embodiment, the amino acid composition comprises branch-chain amino acids. In one embodiment, the amino acid composition comprises leucine, isoleucine, valine, their derivative or a combination thereof. In one embodiment, the amino acid composition comprises a stimulant amino acid or its derivative. Example stimulant amino acids include tryptophan, aspartate, N-methyl-D-aspartate (NMDA), L-carnitine, or their derivatives thereof.

The synergistic composition may be configured to enhance caffeine stimulant effect, reduce the jittery or cardiovascular side effects, or a combination thereof. In one embodiment, the synergistic composition is configured to reduce the side effects of caffeine such as jittery and anxiety. In one embodiment, the synergistic component may have the effect of reducing blood pressure, dilating blood vessel, In one embodiment, the synergistic composition comprises magnesium, L-theanine, theobromine, piraletam, citicoline, flavonoids, quinones, blubbery extract or isolates, arginine, vitamin E, bacopa, curcumin, ginseng, citrulline, icariin, forskin, S-denosyl-L-methionine, quercetine, taurine, salvia, Ginkgo biloba, ferulic acid, liquiritin, magnolol, and ginsenoside Rb2, Borneol, ginsenoside Rc, artemisinin, chenodeoxycholic acid, daidzin, and bacopaside I, carthamus (honghua), peony root, condonopsis, yingyanghuo, pomegranate, or isolates, extracts or derivatives thereof. In one embodiment, the synergistic composition comprises Ginkgo biloba.

The herbal composition may include Ginko biloba, turmeric, ginger, astragalus, Prunella vulgaris, Pueraria montana var. lobata, Salvia miltiorrhiza, Coptis chinensis, Eucommia ulmoides Oliver, cranberry, blackberry, elderberry extract, cranberry, blueberry, grapeseed, saffron, Sangre de grado (dragon's blood), its extract, powder or derivative thereof.

The highly caffeinated cocoa-based composition may further include a sweetening composition. In one embodiment, the sweetening composition comprises sucrose, fructose, glucose, erythritol, xylitol, sugar, glucose syrup, corn syrup, high fructose corn syrup, trulinose, juice concentrate, tapioca syrup, agave syrup, brown rice syrup, high maltose syrup, invert sugar, artificial sweeteners, saccharin, saccharin salts, cyclamic acid, cyclamic acid salts, aspartame, sucralose, acesulfame, rebaudioside A, rebaudioside B, rebaudioside C, rebaudioside D, rebaudioside E, dulcoside A, dulcoside B, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, acesulfame potassium and other salts, aspartame, alitame, saccharin, neohesperidin dihydrochalcone, cyclamate, neotame, N-[N-[3-(3-hydroxy-4-methoxyphenyl)propyl]-L-.alpha.-aspartyl]-L-phenylalanine 1-methyl ester, N-[N-[3-(3-hydroxy-4-methoxyphenyl)-3-methylbutyl]-L-alpha-aspartyl]-L-phenylalanine 1-methyl ester, N-[N-[3-(3-methoxy-4-hydroxyphenyl)propyl]-L-alpha-aspartyl]-L-phenylal-anine 1-methyl ester, salts thereof, licorice or its extracts or isolates, or a mixture thereof.

Carbohydrates are an important constituent of chocolate. The main purpose of the sugars in chocolate is to provide for sweetness and make the resulting chocolate products sweet; especially the chocolate candy or dessert products. The sugars also provide for the hardness and melting point of the chocolate product and how the product dissolves.

In one embodiment, the sweetening component may comprise a rare sugar. In one embodiment, the rare sugar comprises psicose, sorbose, tagatose, trahalose, palatinose (isomaltulose), or their derivative or combination thereof.

Psicose is nearly identical to sucrose (table sugar) in sweetness but has nearly zero calories and does not promote tooth decay. Tagatose is nearly a sweet as sucrose yet only has 38% of the caloric value of sucrose and is much more tooth friendly than sucrose. Sorbose is equivalent to sucrose in sweetness. They cook and behave like sugars without the caloric significance of sucrose, glucose and fructose and are non-cariogenic.

Trehalose, also known as mycose or tremalose, is a natural alpha-linked disaccharide formed by an α,α-1,1-glucoside bond between two α-glucose units. Trehalose has many significant neurological benefits and antioxidant effects. Due to the digestion of trehalose in the small intestine rather than the mouth, trehalose has a lower glycemic index, lower instance of causing dental decay than most carbohydrates.

Palatinose is the common or trade name for isomaltulose. Palatinose is made by enzymatic rearrangement of the alpha-1,2 bond between the glucose and the fructose molecule to an alpha-1,6 bond. Palatinose is digested by enzymatic action by the enzyme sucrase. However, due to the rearrangement of palantinose vs. sucrose, sucrase hydrolysis of palatinose is much slower. Palatinose has a low insulin index (=30) and a lower instances of tooth decay.

In one embodiment, the sweetening component comprises sugar alcohols. Sugar alcohols are the sugars (glucose, fructose, mannose, galactose, among others) that have been hydrogenated to convert the unsaturated carbonyl (ketone, aldehyde) to an alcohol group. Some common sugar alcohols are sorbitol, mannitol, erythritol, xylitol, isomalt and maltitol. Sugar alcohols are sweet compounds; however, they are not digestible and provide no calories, and they are non-cariogenic.

In one embodiment, the highly caffeinated cocoa-based composition may further include an additive selected from food acids, flavoring agents, coloring agents, humectants, bulking agents, fatty acids, triglycerides, plasticizers, emulsifiers, thickeners, preservatives, or and a mixture thereof.

In one embodiment, the flavoring agent comprises vanilla, chili oil, gingerol, peperine, capsaicin, peppermint oil, spearmint oil, eucalyptus oil, cinnamon oil, grapefruit oil, menthol, mono-menthyl succinate, menthol ethylene glycol carbonate, menthone glycerol ketal, menthyl lactate, (−)-isopulegol, p-menthane-3,8-diols, (−)-monomenthyl glutarate, oil of wintergreen (methylsalicylate), citrus oils, orange oils, fruit essences, rosemary oil, lavender oil, sage oil, rose extra or oil, clary sage oil, thyme oil, sandalwood oil, basil oil, coriander oil, cypress oil, fleabane oil, frankincense oil, geranium oil, fennel oil, oregano oil, Dalmatian sage oil, tarragon oil, cocoa, pineapple flavor, berry flavors or mixtures or derivatives thereof. In one embodiment, the berry flavor comprises flavors, isolates, extracts, or juices of blueberry, raspberry, strawberry, black current, acai berry, bilberry, blackberry, mulberry, boysenberry, cranberry, elderberry, goji berry, gooseberry, huckleberry, or a combination thereof.

The coloring agent may be synthetic or natural. Example natural coloring agents include, without limitation, plant or fruit extract or juice or powder such as, without limitation, beet, strawberry, carrot, spirulina, cochineal, turmeric, curcumin, rosemary, or a combination thereof.

In one embodiment, the highly caffeinated cocoa-based composition comprises at least 1.3% by weight of caffeine. In addition to the caffeine there may be additional mental and physical energizing components in the composition including without limitation vitamin Bs, tyrosine, tryptophan, histidine, arginine, L-theanine, creatine, acetyl-L-carnitine, 2-dimethylaminoethanol (DMAE), Ginkgo biloba, or a combination thereof.

In one embodiment, the highly caffeinated cocoa-based composition is raspberry, orange, coconut, pineapple, cinnamon, chili pepper, jalapeno pepper, all spice, anise, licorice, rose, peppermint, mint, caramel, salted caramel, pumpkin spice, cinnamon, or gingerbread flavored. In one embodiment, the composition is flavored by ground or powdered spice or fruit material. In one embodiment, the composition is flavored using liquid flavorings or extracts such as essential oils. In one embodiment, the composition may be flavored with flower extracts or powders such as rose, honeysuckle, lavender, jasmine, calendula, chamomile, chrysanthemum, Osmanthus fragrans, cilantro, clover, or a combination thereof.

In one embodiment, the highly caffeinated cocoa-based composition is a dark chocolate. In one embodiment, the composition is a milk chocolate. In one embodiment, the milk chocolate comprises at least 12% of milk content. In one embodiment, the milk chocolate comprises from about 15% to about 40% of milk content. In one embodiment, the composition is in the form of chocolate bite or chocolate bar. In one embodiment, the chocolate bit or chocolate bar may further include nuts, dried fruits, or cereals.

In another aspect, the application provides methods of making the highly caffeinated cocoa-based compositions disclosed therein. In one embodiment, the method including combining the cocoa component with the fat component to provide a first mixture; combining the caffeinated component, the complex component and the sweetening component to provide a second mixture. Mixing the first mixture and the second mixture and optionally other ingredient. Mold the mixture and allow cooling.

### EXAMPLES

### Example 1: Caffeinated Chocolate Product

Ingredients: Dutch Processed Cocoa (440 g), cocoa butter (380 g), powdered sugar (320 g), gamma-cyclodextrin (40 g), salt (2.8 g), caffeine (17 g), powdered spice (10 g), for a total weight of 1209.8 g.

The cacao butter and the cocoa power were added and mixed together to provide a hot cocoa liquid. The temperature was increased to 110 C. In a separated container, the cyclodextrin, powdered sugar, salt, caffeine, and spices (cinnamon, ginger, nutmeg, allspice, mace, and cloves) were combined.

The mixture was then slowly added to the hot cocoa liquid. Once the liquid was fully mixed the liquid was transferred to molds. The liquid set into a solid mass overnight.

### Example 2: Caffeinated Chocolate Product

Ingredients: Dutch processed cocoa (440 g), cocao butter (400 g), powdered sugar (320 g), gamma-cyclodextrin (40 g), salt (2.8 g), coconut oil (30 g), caffeine (17 g), powdered spices (10 g), for a total weight of 1259.8 g.

Cacao butter and coconut oil were mixed and heated to 110 C. To a separate container was added the cocoa powder, powdered sugar, cyclodextrin, salt, caffeine and spices (cinnamon, ginger, nutmeg, allspice, mace, and cloves). The powdered mixture was then added to the hot oil liquid. Once the liquid was fully mixed the liquid was transferred to molds. The liquid set into a solid mass overnight.

### Example 3: Caffeinated Chocolate Product

Ingredients: Dutch processed cocoa (220 g), cocao butter (400 g), powdered sugar 300 g), gamma-cyclodextrin (40 g), salt (2.8 g), coconut oil (30 g), fructose (100 g), caffeine (17 g), spice (10 g), for a total weight of 1119.8 g.

Cacao butter and cocoa powder were mixed and heated to 110 C with mixing. To the hot liquid was added the coconut oil. To a separate container was added powdered sugar, gamma-cyclodextrin, salt, caffeine, fructose, and spices (cinnamon, ginger, nutmeg, allspice, mace, and cloves). The powdered mixture was then added to the hot oil liquid. Once the liquid was fully mixed the liquid was transferred to molds. The liquid set into a solid mass overnight.

### Example 7: Astragalus Chocolate Product

Ingredients: Dutch processed cocoa (220 g), cocao butter (400 g), powdered sugar (300 g), gamma-cyclodextrin (40 g), salt (2.8 g), coconut oil (30 g), fructose (100 g), Astragalus extract (100 g), for a total of 1193 grams.

Cacao butter and cocoa powder were mixed and heated to 110 C. To the hot liquid was added the coconut oil. To a separate container was added powdered sugar, cyclodextrin, salt, fructose, and astragalus extract. The powdered mixture was then added to the hot oil. The liquid was transferred to molds. The liquid set into a solid mass overnight.

### Example 8: Allulose Caffeinated Chocolate Product

Ingredients: Dutch processed cocoa (220 g), cocao butter (400 g), D-psicose (300 g), gamma-cyclodextrin (40 g), salt (2.8 g), coconut oil (30 g), fructose (100 g), caffeine (17 g), spice (10 g), for a total weight of 1119.8 grams

Cacao butter and cocoa powder were mixed and heated to 110 C. To the hot liquid was added the coconut oil. To a separate container was added psicose, cyclodextrin, salt, caffeine, fructose, and spices (cinnamon, ginger, nutmeg, allspice, mace, and cloves). The powdered mixture was then added to the hot oil liquid. Once the liquid was fully mixed, the liquid was transferred to molds. The liquid set into a solid mass overnight.

### Example 9: Allulose, Tagatose, Caffeinated Chocolate Product

Ingredients: Dutch processed cocoa (220 g), cocoa butter (400 g), tagatose (100 g), D-psicose (200 g), gamma-cyclodextrin (40 g), salt (2.8 g), coconut oil (30 g), fructose (100 g), caffeine (17 g), spice (10 g), for a total of 1119.8 g.

Cacao butter and cocoa powder were mixed and then heated to 110 C. To the hot liquid was added the coconut oil. To a separate container was added psicose, tagatose, cyclodextrin, salt, caffeine, fructose, and spices (cinnamon, ginger, nutmeg, allspice, mace, and cloves). The powdered mixture was then added to the hot oil liquid. Once the liquid was fully mixed, the liquid was transferred to molds. The liquid set into a solid mass overnight.

### Example 10: Trulinose Caffeinated Chocolate Product

Ingredients: Dutch processed cocoa (440 g), cocao butter (380 g), isomatulose (80 g), trehalose (80 g), d-psicose (160 g), gamma-cyclodextrin (40 g), salt (2.8 g), caffeine (17 g), spices (10 g), for a total of 1209.8 g.

Cacao butter and the cocoa power were mixed and heated to 110 C. In a container were combined the cyclodextrin, powdered sugar, salt, caffeine, and spices (cinnamon, ginger, nutmeg, allspice, mace, and cloves). The powder mixture was then added to the hot cocoa liquids. Once the liquid was fully mixed, the liquid was transferred to molds. The liquid set into a solid mass overnight.

### Example 11: Trulinose Caffeinated Chocolate Product Sweetened with Monk Fruit

Ingredients: Dutch process cocoa (440 g), cacao butter (380 g), isomatulose (80 g), trehalose (80 g), d-psicose (160 g), gamma-cyclodextrin (40 g), salt (2.8 g), caffeine (17 g), spices (2 g), Monk fruit extract (2 g), total 1211.8 g

In a reaction kettle the cacao butter and the cocoa power were added and mixed together. The temperature was slowly increased to 110 deg. C. over a period of 45 minutes with stirring. The result was a dark brown liquid.

In a separated bowl were combined the cyclodextrin, powdered isomaltulose, powdered trehalose, powdered psicose, monk fruit, salt, caffeine, and spices (cinnamon, ginger, nutmeg, allspice, mace, and cloves). The mixture was shifted until homogeneous.

The mixture was then slowly added to the hot cocoa liquid with rapid stirring over a period of 10 minutes. The composite was mixed until homogenous.

Once the liquid was fully mixed the liquid was transferred to molds. The liquid set into a solid mass overnight.

### Example 12: Maltitol, Isomalt, Caffeinated Chocolate Product

Ingredients: Dutch process cocoa (220 g), cacao butter (400 g), maltitol (225 g), isomalt (175 g), gamma-cyclodextrin (40 g), salt (2.8 g), coconut oil (30 g), caffeine (17 g), spice (10 g), total 1119.8 g.

Cacao butter and cocoa powder were mixed and heated to 110 C. To the hot liquid was added the coconut oil. To a separate container was added 220 mesh isomalt, 220 mesh maltitol, cyclodextrin, salt, caffeine, and spices (cinnamon, ginger, nutmeg, allspice, mace, and cloves). The powdered mixture was then added to the hot oil liquid. Once the liquid was fully mixed, the liquid was transferred to molds. The liquid set into a solid mass overnight.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A highly caffeinated cocoa-based composition, comprising,
a cocoa component,
a caffeinated component comprising caffeine,
a fat component,
a sweetening component, and
a complexing component, wherein the complexing component is configured to complex with and therefore reduce the bitterness of the caffeinated component, the cocoa component, or both,
wherein the highly caffeinated cocoa-based composition comprises at least about 1% by weight of caffeine.

2. The highly caffeinated cocoa-based composition of claim 1, wherein the caffeinated component comprises caffeine, a plant extract or powder containing at least 10% of caffeine, vitamin Bs, tyrosin, tryptophan, histidine, arginine, L-theanine, creatine, acetyl-L-carnitine, 2-dimethylaminoethanol (DMAE), Ginkgo biloba, or a combination thereof.

3. The highly caffeinated cocoa-based composition of claim 1, wherein the complexing component comprises nucleic acid, plant powder, cluster dextrin, cyclodextrin, polydextrose, chitosan, poly N-acetylglucosamine, N-acetylglucosamine, or a combination thereof.

4. The highly caffeinated cocoa-based composition of claim 1, wherein the complexing component is configured to complex with caffeine. (Might want a similar claim where the complexing component is configured to complex the flavonoids and polyphenols found in cocoa)

5. The highly caffeinated cocoa-based composition of claim 1, wherein the cocoa component comprises cocoa derivatives selected from theobromine, polyphenol, flavonoids, amino acids, or a combination thereof, and wherein the complexing component is configured to complex with one or more of the cocoa derivatives.

6. The highly caffeinated cocoa-based composition of claim 1, wherein the highly caffeinated cocoa-based composition comprises at least about 1.5% caffeine by weight.

7. The highly caffeinated cocoa-based composition of claim 1, wherein the highly caffeinated cocoa-based composition comprises from about 0.1% to about 25% of the complexing component by weight.

8. The highly caffeinated cocoa-based composition of claim 1, wherein the complexing component comprises cyclodextrin, and wherein the caffeinated cocoa-based composition comprises from about 0.01% to about 25% of cyclodextrin by weight.

9. The highly caffeinated cocoa-based composition of claim 1, wherein the complexing component comprises a plant powder, and wherein the highly caffeinated cocoa-based composition comprises from about 0.05% to about 40% of plant powder by weight.

10. The highly caffeinated cocoa-based composition of claim 9, wherein the plant powder comprises the powder of strawberry, Goji berry, acai berry, blackberry, raspberry, cherry, elderberry, cranberry, date, jujube, orange pulp, melon, fig, powder, pineapple, cinnamon powder, pepper, hemp, or a combination thereof.

11. The highly caffeinated cocoa-based composition of claim 1, comprising from about 20% to about 75% by weight the fat composition.

12. The highly caffeinated cocoa-based composition of claim 1, wherein the sweetening composition comprises a sugar component, a sugar alcohol component, a sugar substitute component, a combination thereof.

13. The highly caffeinated cocoa-based composition of claim 12, wherein the sweetening composition comprises essentially trehalose, palatinose, psicose, tagatose, sorbose, or a combination thereof.

14. The highly caffeinated cocoa-based composition of claim 12, wherein the sweetening component comprises essentially erythritol, xylitol, mannitol, sorbitol, isomalt, maltitol, lactitol, or a combination thereof.

15. The highly caffeinated cocoa-based composition of claim 12, wherein the sugar substitute component comprises stevia extract or derivatives, monk fruit extract or derivatives, katemfe fruit extract or derivatives, artificial sweeteners, saccharin, saccharin salts, cyclamic acid, cyclamic acid salts, aspartame, sucralose, acesulfame, rebaudioside A, rebaudioside B, rebaudioside C, rebaudioside D, rebaudioside E, dulcoside A, dulcoside B, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, acesulfame potassium and other salts, aspartame, alitame, saccharin, neohesperidin dihydrochalcone, cyclamate, neotame, N-[N-[3-(3-hydroxy-4-methoxyphenyl)propyl]-L-.alpha.-aspartyl]-L-phenylalanine 1-methyl ester, N-[N-[3-(3-hydroxy-4-methoxyphenyl)-3-methylbutyl]-L-alpha-aspartyl]-L--phenylalanine 1-methyl ester, N-[N-[3-(3-methoxy-4-hydroxyphenyl)propyl]-L-alpha-aspartyl]-L-phenylal-anine 1-methyl ester, salts thereof, licorice or its extracts or isolates, or a mixture thereof.

16. The highly caffeinated cocoa-based composition of claim 1, further comprising an antioxidant composition, a vitamin composition, a mineral composition, an amino acid composition, a synergistic composition, an herb composition, a prebiotic composition, a probiotic composition, a surfactant composition, an additive, or a combination thereof.

17. The highly caffeinated cocoa-based composition of claim 16, wherein the synergistic composition comprises magnesium, L-theanine, theothromine, piraletam, citicoline, flavonoids, quinones, ubiquinone, arginine, vitamin E, bacopa, curcumin, ginseng, citrulline, icariin, forskin, S-denosyl-L-methionine, quercetine, taurine, salvia, Ginkgo biloba, ferulic acid, liquiritin, magnolol, and ginsenoside Rb2, Borneol, ginsenoside Rc, artemisinin, chenodeoxycholic acid, daidzin, and bacopaside I, carthamus (honghua), peony root, condonopsis, isolates, extracts or derivatives thereof.

18. The highly caffeinated cocoa-based composition of claim 16, wherein the herbal composition comprises Ginko biloba, turmeric, ginger, astragalus, Prunella vulgaris, Pueraria montana var. lobata, Salvia miltiorrhiza, Coptis chinensis, Eucommia ulmoides Oliver, cranberry, blackberry, elderberry, cranberry, blueberry, grapeseed, saffron, Sangre de grado, hemp, cannabidiol, bacopa monnieri, Rhodiola rosea, Panax Ginseng, nicotine, acylprolyldipeptide, piracetam, phenylpiracetam, huperzine-A, Huperzia seratta extract or powder, Ashwagandha, Gotu Kola, Lemon Balm, its extract, powder or derivative thereof.

19. The highly caffeinated cocoa-based composition of claim 16, wherein the prebiotic composition comprises gum arabic, chicory root, wheat bran, resistant starch, mannose oligosaccharide, acacia gum, inulin, galacto-oligosaccahride, guar gum, Artichoke fiber, fructo-ligosaccharide, or a combination thereof.

20. The highly caffeinated cocoa-based composition of claim 1, having a glycemic index of not more than 15.
